(19) United States
(12) Patent Application Publication
(10) Pub. No.: US 2006/0285935 A1
(43) Pub. Date: Dec. 21, 2006

(54) Drill structure having cutting blade

(76) Inventor: Chi-Chin Lin, Daliao Township (TW)

Correspondence Address: RABIN & BERDO, P.C.;Suite 500, 1101 14th Street, N.W., Washington, DC, 20005, US

(21) Appl. No.: 11/154,722

(22) Filed: Jun. 17, 2005

(51) Int. Cl. B23B 51/02

(52) U.S. Cl. 408/230

(57) ABSTRACT

This invention relates to a drill structure having cutting blade, comprises a drill tip, a cone top part, head part, cutting part, scrap-guiding slot and drill body. The drill tip forms a top end tip of a cone point, the cone top part is installed underneath the drill tip, its head part is a columnar body takes the cone top part, a pair of blade parts is installed at two halves of the cone top part respectively, the blade parts extend a cutting angle from the cone top part, the scrap-guiding slot is a slope surface extends from the drill tip through the cone top part to the head part, the drill body comprises at least one scrap-release screw line; a scrap-release slope is installed in between the scrape surface and drill tips to enhance the hole-drilling precision, drilling capability and scrap-release capability.

### BACKGROUND OF THE INVENTION

1. Field of the Invention

This invention relates to a cutting capability improvement structure for a drill, it more specifically relates to a drill tip of a drill wherein the drilling point is modified to be a single point.

2. Description of the Prior Art

The drill used in conventional drilling operation is as shown in FIG. 1(a) and FIG. 1(b), the drill 10a comprising of a cylindrical cutting part 20a and a drill body 30a, drill body 30a provides a pair of screw slots 40a and a clamp part 50a. The clamp part 50a is used for the fixing of the clamp of the drilling tool. The cutting part 20a of the drill 10a is normally of cone shape, its tip forms a ridge line 21a, extending from here is a pair of radially reverse blades 22a, the extended part of the blade 22a is further connected to the screw slot 40a. In the above-mentioned drill 10a, since the cutting part 20a is of cone shape, therefore, a large drilling resistance is created when it drills into the work object and the drilling point could easily slide away and the drilling efficiency is thus low, in addition, the scrap-release design is so bad such that the scrap during the drilling generated by the cutting part 20a of the drill can not be effectively released, it thus remains in the drilling hole which in turn creates more so-called second resistance to the drilling operation.

Furthermore, since the prior art drill tip which contacts the work object usually forms a ridge line 21a, the ridge line 21a has alignment precision difficulty when it is in contact with work object, this usually causes drilling position error.

### SUMMARY OF THE INVENTION

To solve the drawbacks of the prior art drill, the inventor spends a great deal of efforts to create the current invention based on more than 10 years of experiences. The product of this invention can be automatically produced through automatic machines, therefore, in-line operation, shape formation in once as well as high speed mass production goals can be achieved, it is a brand new design and structure drill having improved drilling precision, drilling capability, heat-dissipation capability, and scrap-release capability.

The main purpose of the current invention is to provide a more efficient drill structure, a drill tip at the end of a cone located at the most front edge of the drill is used to precisely align the hole position; the cone top part is used to enhance heat dissipation capability; the blade part and the cutting angle of the cutting part is used to enhance the drilling capability; the scrap-release slot is used to enhance high heat dissipation and high scrap-release capability.

### BRIEF DESCRIPTION OF THE DRAWINGS

FIG. 1(a) is the top view of the prior art drill.

FIG. 1(b) is the front view of FIG. 1(a).

FIG. 2 is the stereo figure of the current invention.

FIG. 3 is the top view of FIG. 2.

FIG. 4 is the front view of FIG. 2.

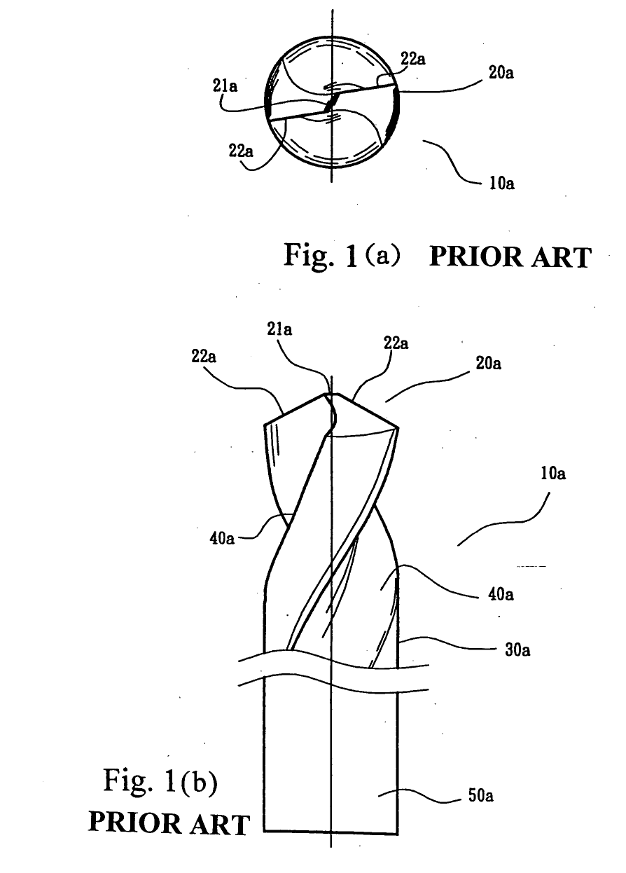

### DETAILED DESCRIPTION OF THE PREFERRED EMBODIMENTS

The preferred embodiment of the current invention is described in the following accompanied with the drawings.

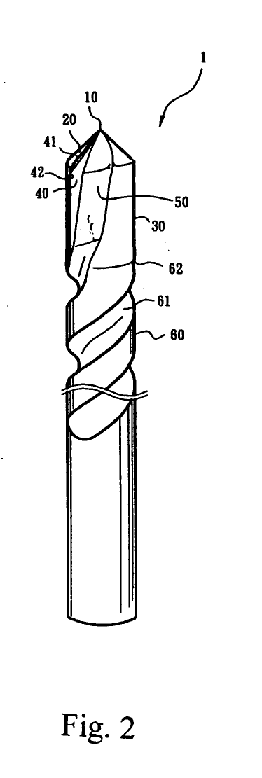

Please refer to FIG. 2, the stereo figure of the current invention. A drill 1 comprising of at least:

A drill tip 10 is located at the most front edge of the drill, it forms a top end tip at the cone point.

A cone top part 20, installed underneath the drill tip 10, the cone angle 21 on the cone top is larger than 90 degrees, when it is set at about 105 degrees, it is the attack angle of a better drill 1.

A head 30, it is a columnar body installed downward after taking the cone top part 20;

A pair of cutting parts 40, a pair of blade parts 41 are opened at the cone top part 20, the pair of blade parts 41 extend downward a cutting angle 42 along the cone top part 20.

A scrap-guiding slot 50, is a slope surface installed from the drill tip 10, along cone top part 20 to the head part 30.

A drill body 60, it takes the head part 30 by an inward constricted guiding angle 62 and comprises of at least one scrap-release screw line 61.

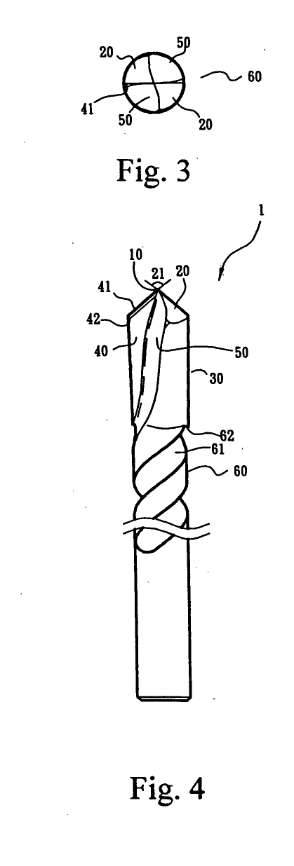

Please continue to refer to FIGS. 3 and 4, according to the above-mentioned components, after the drill 1 is clamped to the clamp of the electrical tools (not shown in the figure), it starts to cut the work object, at this moment, the drill tip 10 which forms a point can precisely drill an alignment point on the work object, after that, it drills into the work object through the blade part 41 of the cutting part 40 installed at the cone top part 20, and the cutting angle 42 neighboring to the blade part 41 of the cutting part 40 performs deeper drilling, then through the scrap-guiding slot 50 to guide rapidly the scrap into the scrap-release screw line 61 of the drill body 60, finally, the scrap-guiding screw line 61 brings the scrap to the surface of the work object.

Furthermore, during the drilling process, the structure designed by this invention, that is, when the cone top part 20 of the drill 1 contacts the work object and rotates to the scrap-guiding slot 50, it can forms an excellent heat dissipation effect.

We know from the above descriptions, this invention indeed improves the drawbacks of prior art drill such as: drilling point sliding, too slow in the drilling speed, as well as difficulty in scrap releasing, etc., it does fulfills the requirements of a patent application. The above-mentioned is only a preferred embodiment of the current invention, it is not used to limit the practical scope of the current invention. Any equivalent change or modification according to the claims of the current invention shall still fall within the scope of the claims of this invention.

What is claimed is:

1. A drill structure having cutting blade, comprising of:
A drill tip forms a top end tip of a cone point;
A cone top part installed underneath the drill tip and forms a cone angle;
A head part which is a columnar body installed downward after taking the cone top part;
A pair of cutting parts which are a pair of blade parts installed at two halves at the cone top part respectively, the pair of blade parts extend downward a cutting guiding angle along the cone top part;
A pair of scrap-guiding slots which are slope surfaces installed from the drill tip and along the cone top part to the head part; and
A drill body which takes the head part and composes of at least one scrap-release screw line.

2. The drill structure of claim 1 wherein the cone angle at the cone top part is larger than 90 degrees.

3. The drill structure of claim 1 wherein there is an inward constricted guiding angle at the connecting part between the head part and the drill body.
